(19) United States
(12) Patent Application Publication
(10) Pub. No.: US 2012/0278539 A1
(43) Pub. Date: Nov. 1, 2012

(54) MEMORY APPARATUS, MEMORY CONTROL APPARATUS, AND MEMORY CONTROL METHOD

(75) Inventor: Yuto Hosogaya, Tokyo (JP)

(73) Assignee: SONY CORPORATION, Tokyo (JP)

(21) Appl. No.: 13/422,867

(22) Filed: Mar. 16, 2012

(30) Foreign Application Priority Data
Apr. 27, 2011 (JP) 2011-099668

(51) Int. Cl. G06F 12/00

(52) U.S. Cl. 711/103; 711/E12.008; 711/E12.009

(57) ABSTRACT

A memory apparatus includes: a plurality of flash memory sections connected to a common data line; and a control section configured to perform control for data read/write on the plurality of flash memory sections, wherein the control section performs control so as to give a read instruction to a first flash memory section among the plurality of flash memory sections to output read data from the first flash memory section onto the common data line, and to give a write instruction to a second flash memory section other than the first flash memory section to write the read data obtained on the common data line into the second flash memory section with timing in accordance with timing of outputting the read data from the first flash memory section.

### CROSS REFERENCES TO RELATED APPLICATIONS

The present application claims priority to Japanese Priority Patent Application JP 2011-099668 filed in the Japan Patent Office on Apr. 27, 2011, the entire content of which is hereby incorporated by reference.

### BACKGROUND

The present disclosure relates to a memory apparatus including a flash memory, a memory control apparatus performing data read/write control on a flash memory, and a method thereof.

A flash memory has become widespread as a kind of nonvolatile memory.

In particular, a NAND-type flash memory is inexpensive, and has a relatively high data-read/write speed as a flash memory, and thus the NAND-type flash memory is expected to replace existing storage apparatuses, such as a HDD (Hard Disk Drive), and the like.

In a NAND-type flash memory, a read/write speed varies depending on a data storage location, and a unit of erasure is large in comparison with a unit of read/write. Accordingly, in order to maintain a high performance, garbage collection operations are performed on a regular basis (for example, refer to Japanese Unexamined Patent Application Publication No. 2007-193883).

In a garbage collection operation, valid data scattered around in a plurality of blocks in a flash memory are gathered and merged into a predetermined block, and thus the garbage collection operation involves data copy from a flash memory to another flash memory in many cases.

### SUMMARY

Here, NAND-type flash memories are provided with a so-called copy command (a copy back command). However, this copy command is a command that is based on the premise that a copy destination and a copy source are within a same flash memory. It is not allowed to use the copy command at the time of data copy to another flash memory, for example, in the case of data copy accompanied by the occurrence of the garbage collection as described above.

Accordingly, in a related-art flash memory, when data is copied between different flash memories, it has been necessary to read data from a copy-source flash memory to an external buffer once, and then to transfer and write the data into a copy-destination flash memory.

A description will be given of a time length that has been necessary for related-art data copy with reference to FIGS. 13A and 13B.

For comparison, FIG. 13A illustrates a case of using the above-described copy command. FIG. 13B illustrates a case of data copy between different flash memories as described above.

In FIG. 13B, to date, when data copy has been carried out between different flash memories, a read command is issued first, and data read is carried out from a flash memory of a copy source. The read data is stored into a buffer memory through a data line.

And after completion of the read out (storage), a write command is issued to a flash memory of a copy destination. Thereby, the read data stored as described above is written into the flash memory of the copy-destination.

In this regard, in the case of using a copy command in FIG. 13A, a target of the data copy is included within the flash memory, and thus it is not necessary to transfer the read data to a buffer memory. Accordingly, in this case, a time length that is necessary for copying becomes about half the time length in the case of FIG. 13B.

In this manner, in a related-art method, when data is copied between different flash memories, the data is transferred through a buffer memory, and thus data transfer occurs on a data line two times. As a result, processing speed tends to be decreased.

The present disclosure has been made in view of these problems. In a memory apparatus including a flash memory, it is desirable to increase a speed of data copy to another flash memory, for example in the case of data copy accompanied by the occurrence of garbage collection, etc., in the same manner as the case of using a copy command.

According to an embodiment of the present disclosure, there is provided a memory apparatus.

That is to say, the memory apparatus according to the embodiment includes a plurality of flash memory sections connected to a common data line.

Also, the memory apparatus includes a control section configured to perform control for data read/write on the plurality of flash memory sections.

And the control section performs control so as to give a read instruction to a first flash memory section among the plurality of flash memory sections to output read data from the first flash memory section on the common data line, and to give a write instruction to a second flash memory section other than the first flash memory section to write the read data obtained on the common data line into the second flash memory section with timing in accordance with timing of outputting the read data from the first flash memory section.

Also, according to another embodiment of the present disclosure, there is provided a memory control apparatus.

That is to say, the memory control apparatus according to the embodiment is a memory control apparatus for performing data read/write control on a plurality of flash memory sections connected to a common data line, the memory control apparatus performing control including: giving a read instruction to a first flash memory section among the plurality of flash memory sections to output read data from the first flash memory section on the common data line; and giving a write instruction to a second flash memory section other than the first flash memory section to write the read data obtained on the common data line into the second flash memory section with timing in accordance with timing of outputting the read data from the first flash memory section.

Also, according to another embodiment of the present disclosure, there is provided a method of controlling a memory.

That is to say, the method of controlling a memory according to the embodiment is a method of controlling a memory for performing data read/write control on a plurality of flash memory sections connected to a common data line, the method including: giving a read instruction to a first flash memory section among the plurality of flash memory sections to output read data from the first flash memory section on the common data line; and giving a write instruction to a second flash memory section other than the first flash memory section to write the read data obtained on the common data line into the second flash memory section with timing in accordance with timing of outputting the read data from the first flash memory section.

By the above-described configuration, it is possible to concurrently perform reading data from the first flash memory section and writing the read data into the second flash memory section.

Since it is possible to write the read data obtained on the above-described common data line into another flash memory section in parallel, it is possible to dramatically improve a copy speed compared with a related-art case in which use of a buffer memory is necessary at the time of copying data to another flash memory.

By an embodiment of the present disclosure, it is possible to perform reading data from the first flash memory section and writing the read data into the second flash memory section in parallel. Accordingly, it is possible to shorten a copy time period to a substantially same time period as in the case of using a related-art copy command.

Additional features and advantages are described herein, and will be apparent from the following Detailed Description and the figures.

### BRIEF DESCRIPTION OF THE FIGURES

FIG. 1 is a diagram illustrating an internal configuration of a memory apparatus according to a first embodiment;

FIG. 2 is a diagram for explaining a time length necessary for data copy in the case of employing a memory control method according to the first embodiment;

FIG. 3 is a diagram mainly illustrating a configuration to be included in a control section of the memory apparatus according to the first embodiment;

FIG. 4 is a timing chart of individual signals used for achieving the memory control method according to the first embodiment;

FIG. 5 is an explanatory diagram on Data Setup Time (tDS) and Data Hold Time (tDH) in the case of the first embodiment;

FIG. 6 is a timing chart illustrating operation waveforms in the case where the memory control method according to the first embodiment is performed in accordance with an EDO mode;

FIG. 7 is a flowchart illustrating a specific processing procedure to be carried out in order to perform the memory control method according to the first embodiment;

FIG. 8 is a diagram for illustrating an internal configuration of a memory apparatus according to a second embodiment;

FIG. 9 is a timing chart for illustrating the memory control method according to the second embodiment;

FIG. 10 is an explanatory diagram on Data Setup Time (tDS) and Data Hold Time (tDH) in the case of the second embodiment;

FIG. 11 is a diagram illustrating an internal configuration of a memory apparatus according to a third embodiment;

FIGS. 12A and 12B are flowcharts illustrating a specific processing procedure to be carried out in order to perform the memory control method according to the third embodiment; and

FIGS. 13A and 13B are diagrams for explaining a time length necessary for related-art data copy.

### DETAILED DESCRIPTION

In the following, descriptions will be given of embodiments of the present disclosure.

In this regard, the descriptions will be given in the following order.

1. First embodiment

1.1 Internal configuration of memory apparatus

1.2 Memory control method according to first embodiment

1.3 Processing procedure

2. Second embodiment

2.1 Internal configuration of memory apparatus

2.2 Memory control method according to second embodiment

3. Third embodiment

3.1 Internal configuration of memory apparatus and memory control method

3.2 Processing procedure

4. Variations

### 1. First Embodiment

### 1.1 Internal Configuration of Memory Apparatus

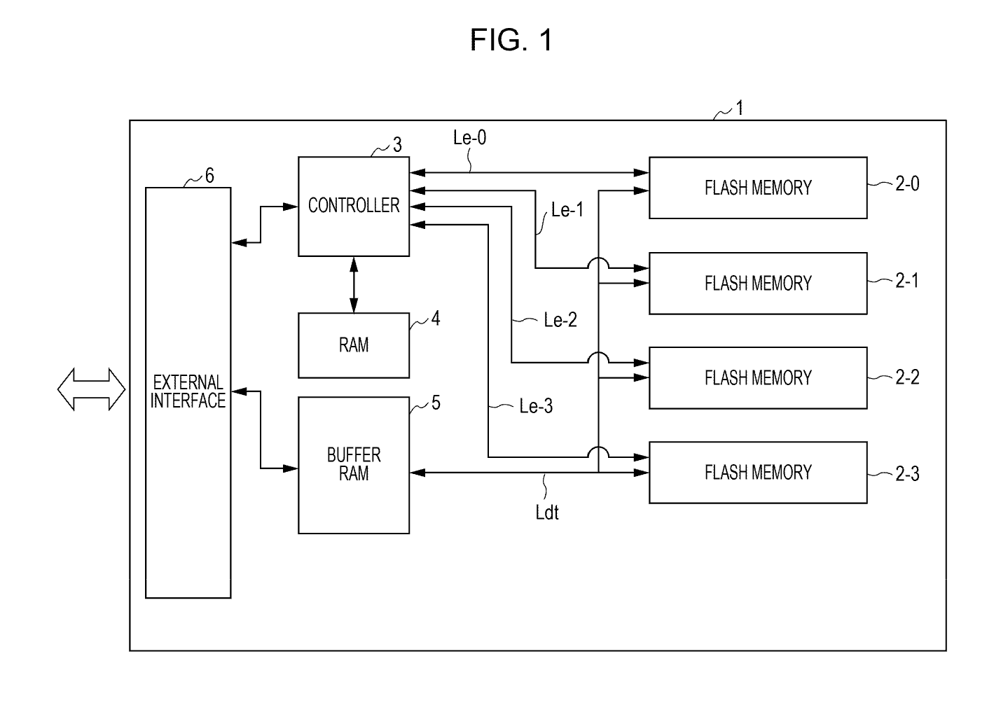

FIG. 1 illustrates an internal configuration of a memory apparatus (hereinafter referred to as a memory apparatus 1) according to a first embodiment of the present disclosure.

In FIG. 1, as illustrated in the figure, the memory apparatus 1 includes a plurality of flash memories 2, a controller 3 for performing write/read control on the flash memories 2, a RAM (Random Access Memory) 4 for use as a work area of the controller 3, a buffer RAM 5 in which read/write data of the flash memory 2 is temporarily stored, and an external interface 6.

The flash memory 2 is assumed to be a NAND-type flash memory. In FIG. 1, an example including four flash memories 2 is illustrated. The individual flash memories are denoted by a flash memory 2-0, a flash memory 2-1, a flash memory 2-2, and a flash memory 2-3.

As illustrated in FIG. 1, each signal line Le is connected between a corresponding one of the flash memories 2 and the controller 3. It is assumed that a signal line Le between the flash memory 2-0 and the controller 3 is a signal line Le-0, a signal line Le between the flash memory 2-1 and the controller 3 is a signal line Le-1, a signal line Le between the flash memory 2-2 and the controller 3 is a signal line Le-2, and a signal line Le between the flash memory 2-3 and the controller 3 is a signal line Le-3.

A signal line Le of interest is a signal line for supplying an enable signal (a read enable signal, or a write enable signal, which is described later), to be used for instructing data read timing from or data write timing to a flash memory 2 to be a target of reading or writing. In this regard, in this meaning, a signal line Le is also denoted by an enable signal line Le.

Also, a common data line Ldt is connected to each of the flash memories 2. As illustrated in FIG. 1, the data line Ldt is also connected to the buffer RAM 5. Thereby, it is possible to supply write data from the buffer RAM 5 to the flash memory 2, and to supply read data from the flash memory 2 to the buffer RAM 5.

In this regard, for the wiring lines between the controller 3 and the flash memories 2, only the wiring lines related to a memory control method according to the present embodiment are specifically illustrated. In reality, for example, the other wiring lines, such as signal lines for achieving addressing for reading/writing, etc., are also connected.

The controller 3 performs overall control of the memory apparatus 1.

Specifically, for example, the controller 3 performs interpretation of a command that the external interface 6 received from an external host device, data write/read control on the flash memory 2 in accordance with the command, generation of various kinds of management information for managing record data in the flash memory 2, etc. Further, the controller 3 performs ECC (Error Correction Code) data generation and addition at the time of writing data into the flash memory 2, and ECC-error correction processing at read time, etc.

The external interface 6 is disposed in order to enable transmission and receiving of various kinds of data between the external host device and the controller 3. The external interface 6 receives a command from the above-described host device, and performs data transmission and receiving, etc.

Data instructed to be written from the host device is temporarily stored into the buffer RAM 5 through the external interface 6, and then is written into a predetermined flash memory 2 (address) through the data line Ldt under the control of the controller 3.

Also, if the host device gives a read instruction of data that was written in a certain flash memory 2 (address), read data from the flash memory 2 is temporarily stored into the buffer RAM 5 through the data line Ldt under the control of the controller 3, and then is transmitted to the host device through the external interface 6.

### 1.2 Memory Control Method According to First Embodiment

In the present embodiment, a configuration in which the common data line Ldt is connected to each of the flash memories 2 is employed, and when data copy to a different one of the flash memories 2 occurs, copy processing by the following method is performed.

That is to say, a read instruction is given to a flash memory 2 to be a copy source of data among the flash memories 2 so that read data is output from the flash memory 2 of the copy source onto the data line Ldt. At the same time, a write instruction is given to a flash memory 2 of a copy destination at timing in accordance with timing of outputting the read data from the flash memory 2 of the copy source. Thereby, the read data obtained on the data line Ddt as described above is written into the flash memory 2 of the copy destination.

By such a method, it is possible to concurrently carry out reading data from the flash memory 2 of the copy source, and writing the read data into the flash memory 2 of the copy destination.

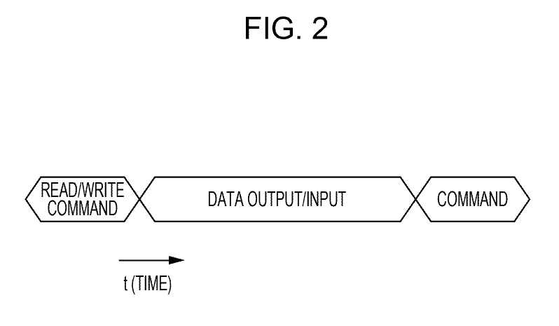

FIG. 2 is a diagram for explaining a time length necessary for data copy in the case of employing a memory control method according to the present embodiment.

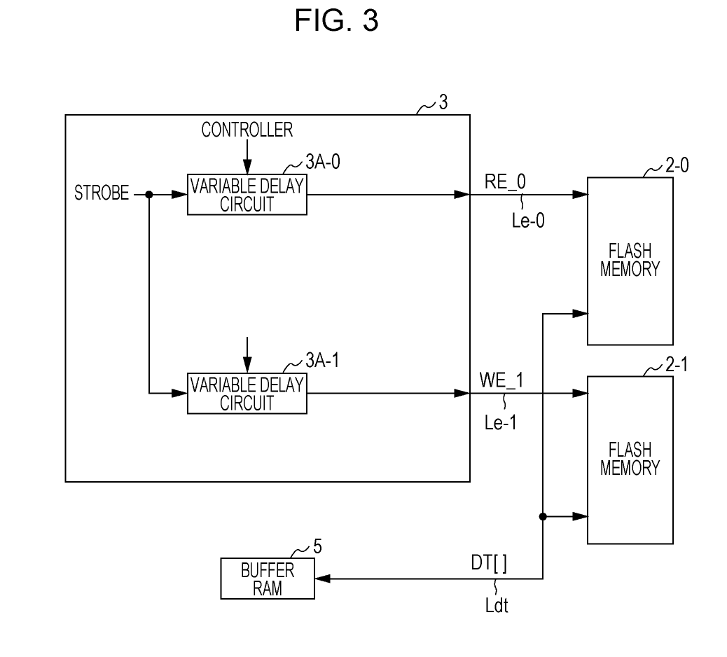

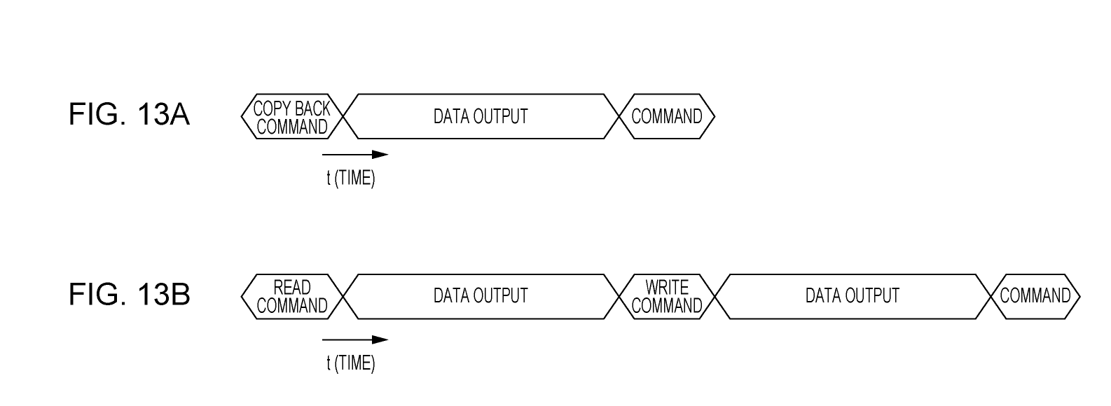

As is understood in comparison with the cases in FIGS. 13A and 13B, by the present embodiment, it is possible to make a time length necessary for data copy to another flash memory 2 identical to the time length in the case of using the copy command illustrated in FIG. 13A. Thus, compared with a related-art method, illustrated in FIG. 13B, by which use of a buffer memory is necessary at the time of data copy, it is possible to reduce a copy-time length to about a half Descriptions will be given of a specific configuration for achieving a memory control method and control contents as the present embodiment described above with reference to FIGS. 3 to 5.

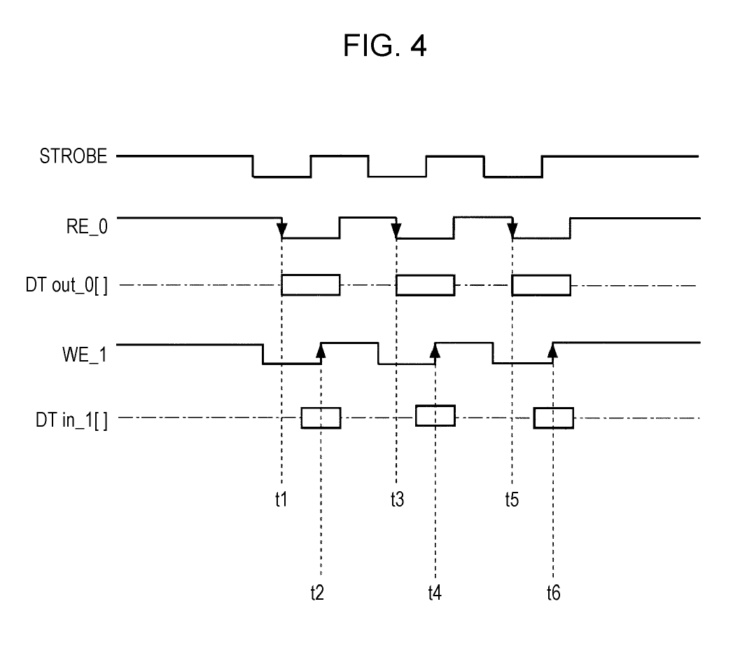

FIG. 3 is a diagram mainly illustrating a specific configuration to be included in the controller 3 for achieving the memory control method according to the present embodiment. FIG. 4 is a timing chart of individual signals used for achieving the method of controlling a memory according to the present embodiment. In this regard, DT stands for Data in FIG. 4.

In FIG. 3, together with a configuration necessary for the controller 3, the flash memories 2, the buffer RAM 5, the enable signal lines Le, and the data line Ldt, which are illustrated in FIG. 1, are also illustrated. For the convenience of illustration, it is assumed that only the flash memory 2-0 and the flash memory 2-1 are disposed regarding the flash memories 2.

Here, in the following description, a case where a copy source of data is the flash memory 2-0, and a copy destination is the flash memory 2-1 is exemplified.

In FIG. 3, the controller 3, in this case, generates a strobe signal (Strobe) on the basis of a clock CLK. A frequency of the strobe signal matches a frequency of the clock CLK.

In this example, the controller 3 individually generates a read enable signal RE and a write enable signal WE on the basis of the strobe signal. Specifically, the controller 3 has a plurality of variable delay circuits 3A receiving input of the strobe signal. These variable delay circuits 3A generate the read enable signal RE and the write enable signal WE from the strobe signal.

In this example, each of the variable delay circuits 3A is disposed for each corresponding one of the enable signal lines Le. That is to say, for each of the flash memories 2.

In this case, for enable signal lines Le, only Le-0 and Le-1 are disposed, and thus for the variable delay circuits 3A, two circuits, namely a variable delay circuit 3A-0 corresponding to the signal line Le-0, and a variable delay circuit 3A-1 corresponding to the signal line Le-1, are disposed.

Here, as is understood with reference to FIG. 4, the read enable signal RE has a delay of ¼ cycle in phase from the strobe signal. That is to say, in the controller 3 in this case, when data written in a certain flash memory 2-x is read, the amount of delay of the variable delay circuit 3A-x connected to an enable signal line Le-x that is connected to the flash memory 2-x is set to the amount of delay of ¼ cycle of the strobe signal.

In the case where data of the flash memory 2-0 is copied to the flash memory 2-1 just like in this example, when data to be copied is read from the flash memory 2-0, an amount of delay of ¼ cycle of the strobe signal is set to the variable delay circuit 3A-0, and the read enable signal RE is given to the flash memory 2-0.

In this regard, hereinafter, an amount of delay set to the variable delay circuit 3A for generating the read enable signal RE is described as an “amount of read delay” for the sake of convenience.

In response to supply of the read enable signal RE like this, as illustrated “DT out_0” in FIG. 4, one-bit data is read in sequence from the flash memory 2-0 of the copy source at each falling timing of the read enable signal RE (points in time t1, t3, and t5).

Here, in this manner, the data read from the flash memory 2-0 is output onto the data line Ldt. At this time, it takes a certain time until the read data is obtained on the data line Ldt.

Accordingly, the write enable signal WE, which is to be given to the flash memory 2-1 in order to write the read data from the flash memory 2-0 to the flash memory 2-1, is generated such that the write timing indicated by the write enable signal WE is delayed for a predetermined time period from the read timing indicated by the read enable signal RE that was given to the flash memory 2-0 of the copy source.

In this regard, in this example, the write enable signal WE indicates data write timing by the rising timing of the signal (points in time t2, t4, and t6).

Here, in the case of a NAND-type flash memory, timing at which the signal input and output on the data line Ldt becomes valid with respect to the signal line Le is specified by a vendor.

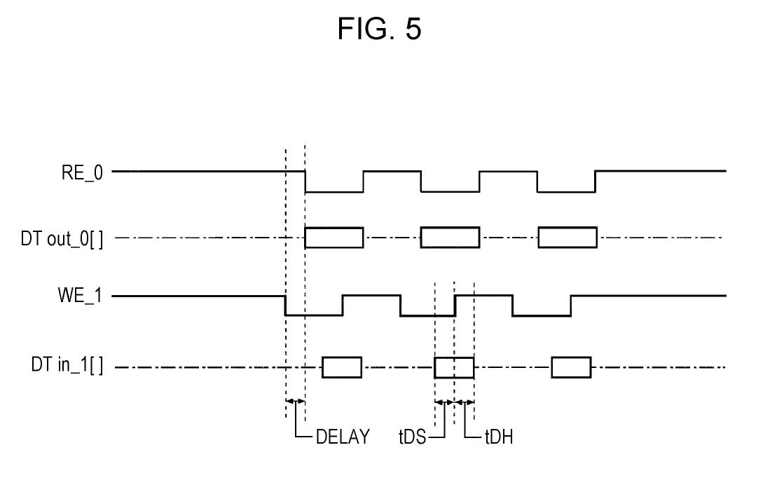

As illustrated in FIG. 5, the vendor specifies Data Setup Time (tDS), which is a necessary time period during which valid data is set before a rising edge of the write enable signal WE, and Data Hold Time (tDH), which is a necessary time period during which valid data is continued to be set thereafter.

For example, if specified that the tDS is 5 ns, and the tDH is 15 ns, it is desirable to delay the read enable signal RE for 5 ns or more with respect to the write enable signal WE (“delay” in FIG. 5).

At this time, the cycle of the enable signal is set to at least 20 ns or more, which is a sum of the tDS and the tDH.

When the read data from the flash memory 2-0 is written into the flash memory 2-1, the controller 3 sets an amount of delay to the variable delay circuit 3A-1 illustrated in FIG. 3 in advance so as to obtain a signal having a phase difference (for example, a phase difference corresponding to the above-described 5 ns) with the above-described read enable signal RE as the write enable signal WE output from the variable delay circuit 3A-1.

In this regard, the amount of delay to be set to the variable delay circuit 3A for generating the write enable signal WE to be supplied to the flash memory 2 of the copy destination at the time of data copy to another flash memory 2 in this manner is described as an “amount of write delay”.

By supplying the write enable signal WE generated as described above, it is possible to reliably write the read data that was read from the flash memory 2-0 and obtained on the data line Ldt into the flash memory 2-1 (copy-destination flash memory) in this case for each one bit.

Here, the description has been given of processing to be performed in response to the data copy from the flash memory 2-0 to the flash memory 2-1 in the above-described description. However, on the contrary, when data is copied from the flash memory 2-1 to the flash memory 2-0, an amount of read delay ought to be set to the variable delay circuit 3A-1, and an amount of write delay ought to be set to the variable delay circuit 3A-0.

In this regard, in some of the NAND-type flash memories, it is possible to set an EDO (Extended Data Output) mode. In the EDO mode, it is also possible to properly copy data to another flash memory by the above-described memory control method in the same manner.

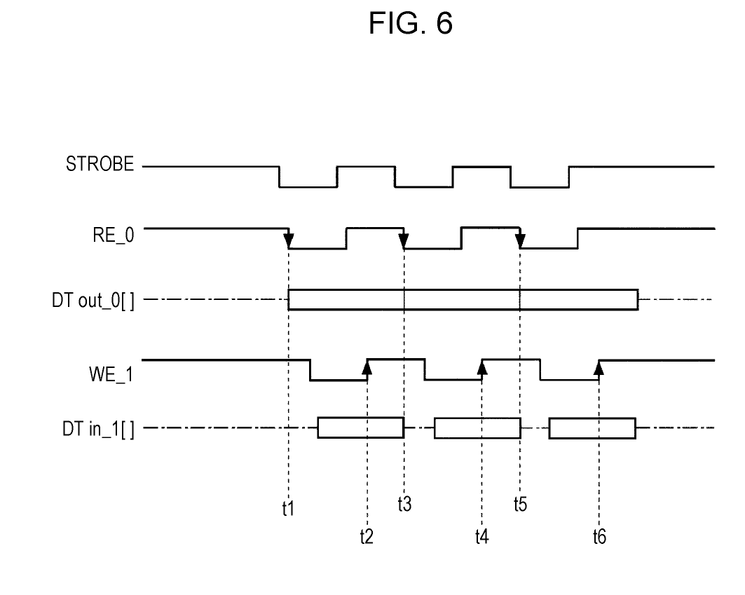

FIG. 6 illustrates operation waveforms, like those in FIG. 4, in the case where a memory control method according to the present embodiment is performed in accordance with the EDO mode. In this regard, a case where data is copied from the flash memory 2-0 to the flash memory 2-1 is also exemplified in this case.

Referring to FIG. 6, it is understood that in the EDO mode, one cycle of the read enable signal RE becomes a read period, and by generating the read enable signal RE to the flash memory 2-0, and the write enable signal WE with respect to the flash memory 2-1 by the above-described generation method, it is also possible to properly write the read data obtained on the data line Ldt from the flash memory 2-0 to the flash memory 2-1, which is the copy destination, in the same manner as the case in FIG. 4.

### 1.3 Processing Procedure

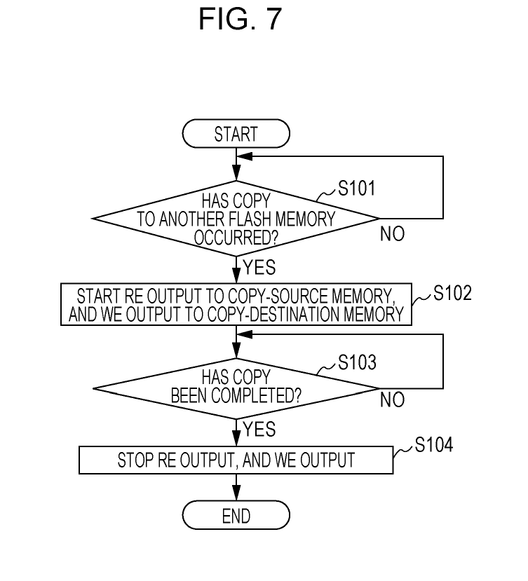

With reference to a flowchart in FIG. 7, a description will be given of a specific processing procedure to be executed by the controller 3 in order to achieve the above-described memory control method.

Referring to FIG. 7, in step S101, an occurrence of copy to another flash memory is waited. That is to say, detection of a state in which data written in a certain flash memory 2 out of the flash memories 2 illustrated in FIG. 1 is to be written into another flash memory 2 is waited.

As is understood from the descriptions so far, as a cause for the occurrence of copy to another flash memory, it is possible to give the occurrence of garbage collection, etc., as an example.

In step S101, if copy to another flash memory occurs, in step S102, processing is performed in order to start outputting a read enable signal RE to a copy-source memory and outputting a write enable signal WE to a copy-destination memory.

In the case of this example, the read enable signal RE and the write enable signal WE are generated by giving a predetermined amount of delay to the strobe signal by the variable delay circuits 3A (the above-described amount of read delay and amount of write delay), respectively. Accordingly, the processing in step S102 includes starting a toggle of the strobe signal, setting the above-described amount of read delay to the variable delay circuit 3A of the copy-source flash memory 2, and setting the amount of write delay to the variable delay circuit 3A connected to the copy-destination flash memory 2.

After the processing in step S102 is performed, the processing is waited until the copy is completed in step S103. That is to say, the processing is waited until data to be copied is all written into the copy-destination flash memory.

In step S103, if copy is completed, the processing proceeds to step S104, and processing for stopping the output of the read enable signal RE and the write enable signal WE is performed. In the case of this example, the toggle of the strobe signal is stopped so that the output of the read enable signal RE and the write enable signal WE is stopped.

After the processing in step S104 is performed, processing for copying to the other flash memory illustrated in FIG. 7 is completed.

By the above-described memory control method according to the present embodiment, it is possible to concurrently perform reading data from the copy-source flash memory and writing the read data into the copy-destination flash memory. Thereby, it is possible to dramatically improve a copy speed compared with a related-art copy method by which use of the buffer memory RAM 5 is necessary at the time of copying to another flash memory.

In this regard, in the above, a description has been mainly given only of the processing for reading data from a copy-source flash memory and writing the read data to a copy-destination flash memory. In reality, in parallel with such concurrent write processing, the controller 3 performs error-checking processing and error correction processing as necessary on the read data (that is to say, data to be stored in the buffer RAM 5) from the copy-source flash memory. At this time, if error correction is performed, the controller 3 performs processing to rewrite the relevant data among the read data written in the copy-destination flash memory with data after the error correction.

Thereby, it is possible to prevent a decrease in data reliability at the time of copying data.

### 2. Second Embodiment

### 2.1 Internal Configuration of Memory Apparatus

Next, a description will be given of a second embodiment.

The second embodiment is an application to a NAND-type flash memory in which a DDR (Double Data Rate) standard is employed.

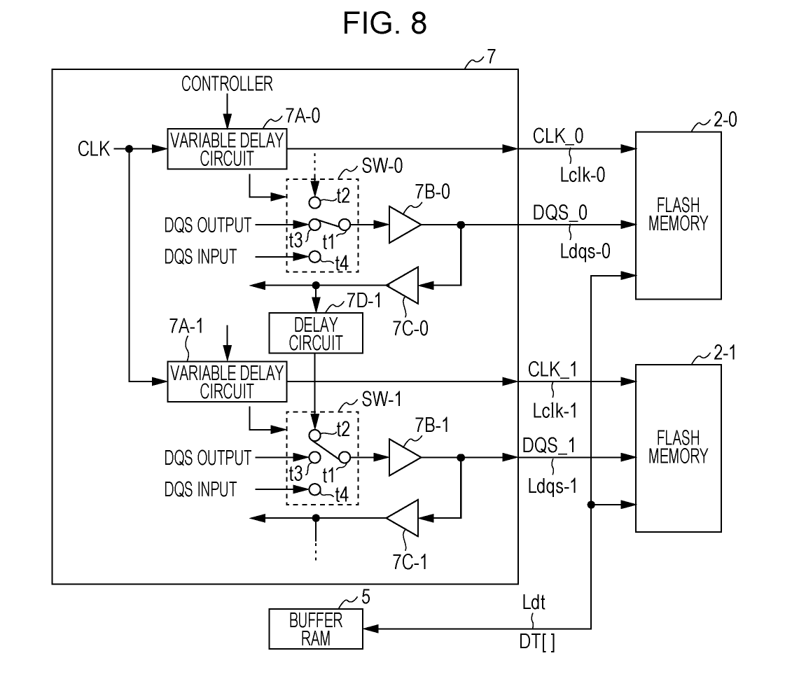

FIG. 8 is a diagram for illustrating an internal configuration of a memory apparatus according to the second embodiment.

In this regard, a memory apparatus according to the second embodiment has a same configuration as that of the memory apparatus 1 according to the first embodiment except that a controller 7 is disposed in place of the controller 3, and wiring lies from the controller 7 to each of the flash memories 2 are different.

Accordingly, in FIG. 8, only an internal configuration and the wiring of the controller 7 are mainly illustrated regarding the configuration of the memory apparatus according to the second embodiment. In this regard, in FIG. 8, in the same manner as in FIG. 3, it is assumed that only the flash memory 2-0 and the flash memory 2-1 are disposed for the flash memories 2. Also, the buffer RAM 5 is illustrated.

In the case where DDR transfer is supported, DQS signal lines Ldqs are independently connected to the corresponding flash memories 2, respectively, in order to supply DQS signals (data strobe signals) to be used for inputting and outputting data from the controller 7 in addition to the read enable signal RE and the write enable signal WE.

As illustrated in FIG. 8, it is assumed that a DQS signal line Ldqs connected to the flash memory 2-0 is “Ldqs-0”, and a DQS signal line Ldqs connected to the flash memory 2-1 is “Ldqs-1”.

As a common knowledge, in the case of employing DDR, at the time of reading data, a DQS signal is output from the flash memory 2, and a receiver (a capture side of read data) captures data at timing indicated by the DQS signal output from the flash memory 2 in this manner.

On the other hand, at the time of writing data, the DQS signal is input into the flash memory 2, and data write timing is instructed.

In this regard, hereinafter, it is assumed that the DQS signal output from the flash memory 2 in response to the read time is referred to as a “DQS output signal” for the sake of convenience, and the DQS signal given to the flash memory 2 for instructing write timing in response to the write time is referred to as a “DQS input signal”.

Here, “DQS output” in FIG. 8 indicates a DQS output signal, which is output from the flash memory 2 in response to the read time.

Also, in FIG. 8, signal lines Lclk of a clock CLK, which are supplied from the controller 7 to the individual flash memories 2, respectively, are illustrated. As illustrated in FIG. 8, it is assumed that a signal line Lclk connected to the flash memory 2-0 is “Lclk-0”, and a signal line Lclk connected to the flash memory 2-1 is “Lclk-1”.

In this regard, in this case, for wiring lines between the controller and the flash memory, only the wiring lines related to the memory control method according to the present embodiment are specifically illustrated. In reality, the other wiring lines, such as signal lines for addressing, etc., are connected, for example. For example, it is possible to give supply lines for a CLE (Command Latch Enable) signal and an ALE (Address Latch Enable) signal, etc., as an example.

As illustrated in FIG. 8, the clock CLK is supplied to the signal lines Lclk through the variable delay circuits 7A disposed in the controller 7.

Specifically, the clock CLK via the variable delay circuit 3A-0 is supplied to the flash memory 2-0 through the signal line Lclk-0. In the same manner, the clock CLK via the variable delay circuit 3A-1 is supplied to the flash memory 2-1 through the signal line Lclk-1.

It is assumed that the clock CLK given to the flash memory 2-0 through the variable delay circuit 3A-0 is “CLK_0”, and the clock CLK given to the flash memory 2-1 through the variable delay circuit 3A-1 is “CLK_1”.

Also, in this case, a same number of switches SW as that of flash memories 2 are disposed in the controller 7. As illustrated in FIG. 8, it is assumed that a switch SW disposed correspondingly to the flash memory 2-0 is “SW-0”, and a switch SW disposed correspondingly to the flash memory 2-1 is “SW-1”. The switch SW in this case is a switch capable of selecting one out of a terminal t2, a terminal t3, and a terminal t4 with respect to a terminal t1. That is to say, the switch SW is configured to select any one of signals input into the terminal t2 or the terminal t3 or the terminal t4 to output the signal from the terminal t1.

As illustrated in FIG. 8, an output of the terminal t1 is supplied to the DQS signal line Ldqs through a buffer amplifier 7B. Here, the DQS signal (DQS input signal) given to the flash memory 2-0 through the DQS signal line Ldqs-0 is denoted as DQS_0, and the DQS signal (DQS input signal) given to the flash memory 2-1 through the DQS signal line Ldqs-1 is denoted as DQS_1.

The DQS input signal is given to the terminal t4 of the switch SW. At the time of normal write operation other than data copy from another flash memory, the terminal t4 is selected, and the DQS input signal is supplied to the flash memory 2 to which data is written.

Also, the DQS output signal that is output at the time of reading the flash memory 2, to which the switch SW is disposed correspondingly, is input to the terminal t3 of the switch SW.

Also, an output from the terminal t1 of the switch SW-0 is input to the terminal t2 of the switch SW-1 through the buffer amplifier 7B-0, the buffer amplifier 7C-0, and the delay circuit 7D-1 in sequence.

In this regard, although not illustrated in FIG. 8 for the sake of illustration, a delay circuit 7D-0 is disposed in the controller 7 as a delay circuit 7D corresponding to a flash memory 2-0. And an output of the terminal t1 of the switch SW-1 is input to the terminal t2 of the switch SW-0 through the buffer amplifier 7B-1, the buffer amplifier 7C-1, and then through the delay circuit 7D-0.

### 2.2 Memory Control Method According to Second Embodiment

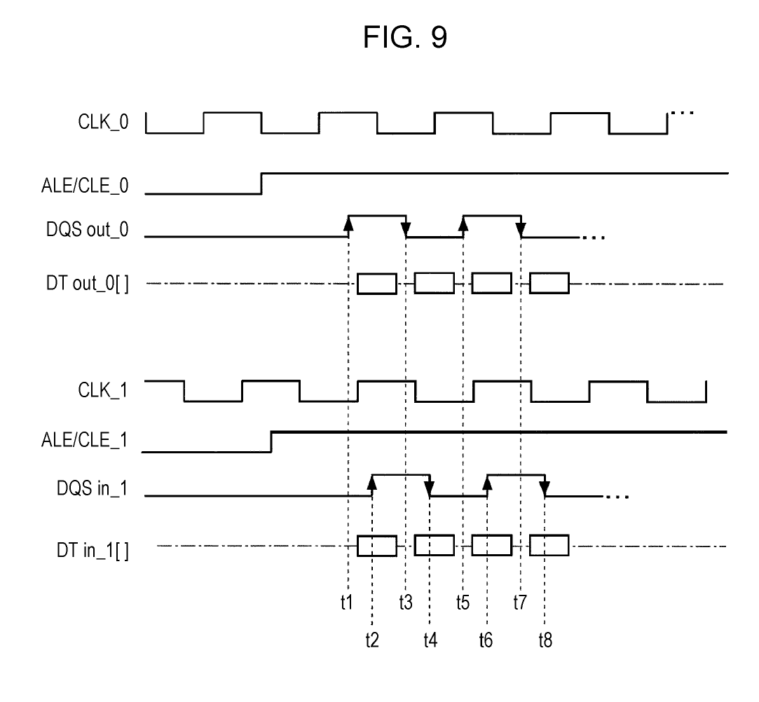

With reference to a timing chart in FIG. 9, a description will be given of a memory control method according to the second embodiment.

In this regard, in FIG. 9, CLK_0, ALE/CLE_0, DQS out_0, DT out_0, CLK_1, ALE/CLE_1 DQS in_1, and DT in_1, which are obtained correspondingly at the time of data copy from the flash memory 2-0 to the flash memory 2-1, are individually illustrated.

In this regard, ALE/CLE_0 and ALE/CLE_1 represent ALE signals and CLE signals that are supplied from the controller 7 to the flash memory 2-0 and to the flash memory 2-1, respectively. DQS out_0 represents the DQS output signal that is output from the flash memory 2-0, and DQS in_1 represents the DQS input signal that is supplied to the flash memory 2-1. In this regard, DT stands for Data in this case.

First, in the case of the second embodiment in which the DDR standard is employed, the DQS output signal denoted by DQS out_0 in FIG. 9 is obtained from the flash memory 2-0 with readout of the flash memory 2-0. The read data in this case is obtained on the data line Ldt each half-cycle period of the DQS output signal.

Here, in the DDR transfer, timing at which the read data is obtained on the data line Ldt does not necessarily match the rising/falling timing of the clock CLK. In particular, a timing difference between the two becomes relatively large with respect to a change in the operation temperature of the flash memory 2.

Accordingly, in this example, the DQS input signal to be given to the copy-destination flash memory 2-1 is not generated on the basis of the clock CLK, but is generated on the basis of the DQS output signal output by the copy-source flash memory 2-0.

Specifically, in the second embodiment, if assumed that data is copied from the flash memory 2-0 to the flash memory 2-1, the terminal t3 is selected by the switch SW-0 illustrated in FIG. 8, and the terminal t2 is selected by the switch SW-1. Thereby, it is possible to supply a signal generated by the delay circuit 7D-1 by giving a predetermined amount of delay to the DQS output signal from the copy-source (that is to say, read target) flash memory 2-0 to the copy-destination flash memory 2-1 as a DQS input signal (write-timing instruction signal).

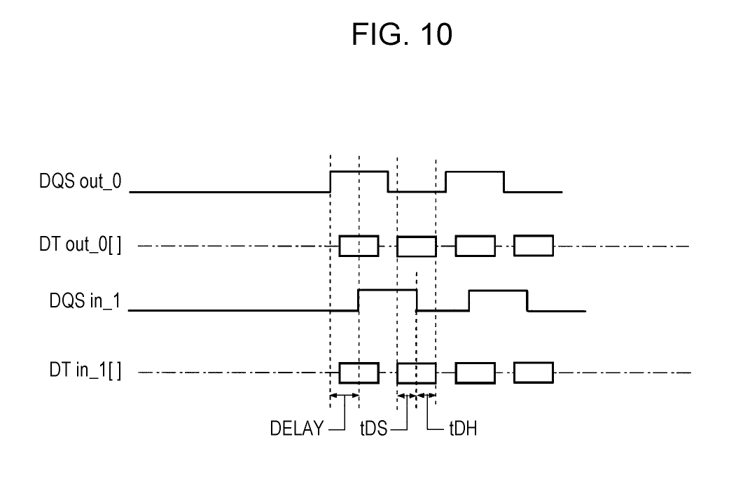

Here, in the case where the DDR is employed, as illustrated in FIG. 10, the vendor specifies tDS, which is a time period in which valid data necessary to be set before rising of the DQS input signal (DQS in_1 in FIG. 10), and tDH, which is a time period in which the valid data is kept thereafter.

For example, in the case where the execution frequency is 100 MHz, that is to say, a cycle of 10 ns, and the tDS and the tDH is set to 1 ns, the amount of delay to be set in the delay circuit 7D is determined such that the DQS output signal having a delay of 2.5 ns from the DQS output signal produced from the copy-destination flash memory is obtained (“delay” in FIG. 10).

In this manner, the DQS input signal generated by giving a predetermined amount of delay to the DQS output signal produced from the copy-destination flash memory 2-0 is supplied to the copy-source flash memory 2-1 so that it is possible for the flash memory 2-1 to properly write the read data, obtained on the data line Ldt, from the flash memory 2-0 in response to the DQS input signal (refer to points in time t2, t4, t6, and t8 in FIG. 9).

Here, as is understood with reference to FIG. 9, the clock CLK_1 supplied to the copy-destination flash memory 2-1 has, with respect to the clock CLK_0, as much delay as the amount of delay given by the delay circuit 7D-1 to the DQS output signal produced from the copy-source flash memory 2-0 as described above. The amount of delay at this time, that is to say, the amount of delay to be set to the variable delay circuit 3A disposed correspondingly to the copy-destination flash memory at the time of generating the clock CLK to be supplied to the copy-destination flash memory is denoted by an “amount of delay at write time”.

The amount of delay at write time is set by the controller 7.

In this regard, in this case, the amount of delay to be set to the variable delay circuit 3A disposed correspondingly to the copy-source flash memory ought to be “0”.

In this regard, in the above, a description has been given of the operation corresponding to the data copy from the flash memory 2-0 to the flash memory 2-1. However, at the time of data copy from the flash memory 2-1 to the flash memory 2-0, the terminal t3 is selected for the switch SW-1, and the terminal t2 is selected to the switch SW-0. Also, together with this, the above-described amount of delay at write time is set to the variable delay circuit 3A-0, and the clock CLK_0 of the copy-destination flash memory 2-0 ought to be delayed from the clock CLK_1 of the copy-source flash memory 2-1.

Also, at the time of normal write, rather than write accompanied by data copy to another flash memory, the terminal t4 is selected for the switch SW disposed correspondingly to the flash memory 2 to which data is written so that a normal DQS input signal is supplied to the flash memory 2 to which data is written.

Also, in FIG. 8, the case where the number of flash memories 2 is two is exemplified. However, it is possible to apply the memory control method according to the second embodiment to the case where the number of flash memories 2 is three or more.

In this case, at least a variable delay circuit 8A, a switch SW, and a delay circuit 7D ought to be disposed for each flash memory 2 in the same manner as the above.

However, in the case where three flash memories 2 or more are disposed, the number of the flash memories 2 to be selected as the copy source becomes two or more, and thus even if any one of the two or more flash memories 2 is selected as a copy source, it is necessary for the switch SW to be configured to allow selectively input the delayed signal of the DQS output signal from the selected flash memory 2 (the DQS output signal after having delayed by the delay circuit 7D=DQS input signal to the copy-destination flash memory). That is to say, terminals for inputting the DQS input signal on the basis of the DQS output signal, as the terminal t2, from the copy-source flash memory are disposed as many as the number of flash memories 2 that can be selected as a copy-source flash memory. It is necessary to configure the switch SW so as to allow selection of a terminal corresponding to the flash memory 2 selected as a copy source from those terminals.

As described above, in the second embodiment, in the case where the DDR standard is employed, an adjustment is made on the write instruction timing indicated by the DQS input signal to be supplied to the copy-destination flash memory 2 in consideration of variations of the data read timing of the copy-source flash memory 2 by operation temperature, etc. Specifically, in the case of DDR, the data read timing of the copy-source flash memory 2 is indicated by the DQS output signal from the flash memory 2, and thus a signal produced by giving a predetermined time delay to the DQS output signal is generated as the DQS input signal to the copy-destination flash memory 2.

Thereby, it is possible to prevent the write timing to the copy-destination flash memory 2 from becoming improper depending on a change in the operation temperature, etc. That is to say, it is possible to prevent the occurrence of an incident in which a write error occurs to the copy-destination flash memory 2 depending on a change in the operation temperature, etc.

In this regard, in the case where the time length of tDH illustrated in FIG. 10 is allowed to be relatively short, etc., it is possible to generate the DQS input signal to be supplied to the copy-destination flash memory 2 on the basis of a timing signal other than the DQS output signal, such as the clock CLK, etc, for example. That is to say, for example, by giving a relatively large amount of delay to the clock CLK in consideration of a timing difference caused by a change in operation temperature, and using the clock as the DQS input signal to the copy-destination flash memory 2, it is also possible to obtain a same temperature compensation effect.

### 3. Third Embodiment

### 3.1 Internal Configuration of Memory Apparatus and Memory Control Method

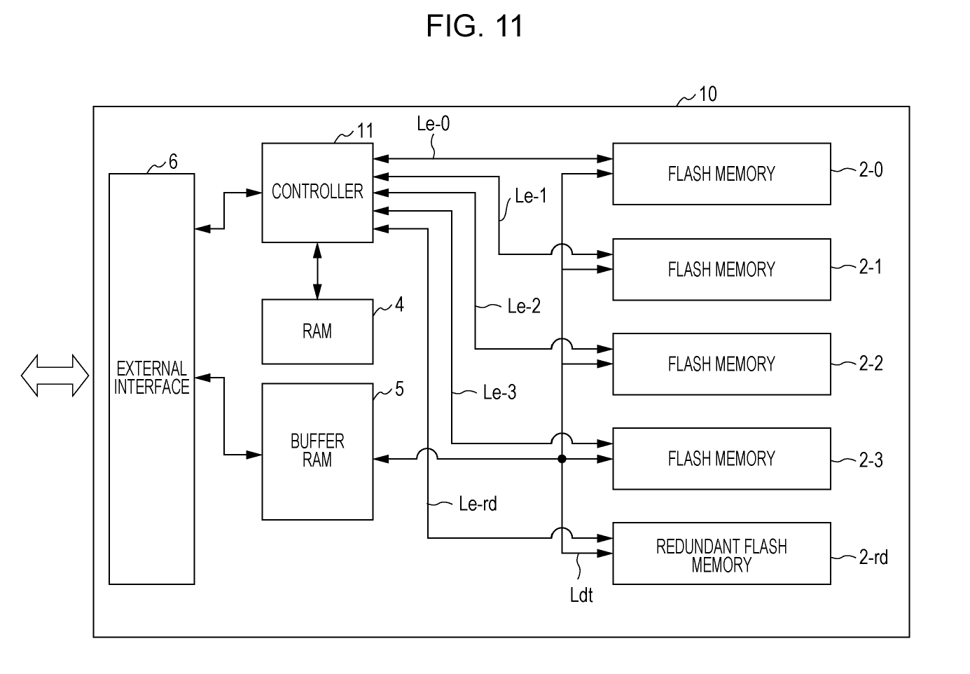

FIG. 11 illustrates an internal configuration of a memory apparatus (memory apparatus 10) according to a third embodiment.

In this regard, in the third embodiment, same reference numerals are given to the parts that have been described so far, and the descriptions thereof will be omitted.

The memory apparatus 10 is different from the memory apparatus 1 according to the first embodiment in the points that a redundant flash memory 2-rd is newly disposed, and a controller 11 is disposed in place of the controller 3. Further, in the memory apparatus 10, a signal line Le-rd is connected between the controller 11 and the redundant flash memory 2-rd. Also, the data line Ldt in this case is connected to the redundant flash memory 2-rd as illustrated in FIG. 11.

The redundant flash memory 2-rd represents a flash memory 2 used for a redundant record area that is not counted for a recording capacity of the memory apparatus 10. That is to say, the redundant flash memory 2-rd is a memory that is not for use for in recording normal user data, etc.

Here, in the memory apparatus 10, a variable delay circuit 3A that is same as that described in FIG. 3 correspondingly to the signal line Le-rd is disposed (referred to as a variable delay circuit 3A-rd) in the controller 11. A strobe signal through the variable delay circuit 3A-rd is input to the signal line Le-rd.

In the third embodiment, such a redundant flash memory 2-rd is disposed, and at the time of data read from any one of the flash memories 2 out of the other flash memories 2-0 to 2-3, read data output from that flash memory 2 onto the data line Ldt is transferred to the buffer RAM 5, and in parallel with this, the read data is also written into the redundant flash memory 2-rd.

Here, the controller 11 performs error-check processing on the read data stored in the buffer RAM 5 in order to determine whether so-called refresh processing is to be performed or not at the time of data read as described above. On the basis of a result of the error-check processing, if a predetermined condition, on which the refresh processing should be performed, for example, when an error portion reaches an upper limit value, etc., (hereinafter referred to as a refresh-execution condition) is met, the controller 11 performs correction processing of the error data in the buffer RAM 5, etc., for refresh processing.

In this regard, descriptions on the refresh processing in a flash memory are included in Japanese Unexamined Patent Application Publication No. 2010-15477, and Japanese Unexamined Patent Application Publication No. 2010-198219, etc., for example.

At this time, in a related-art memory apparatus, if a refresh execution condition is met as a result of the error-check processing on the read data stored in the buffer RAM 5, the error correction processing as described above is performed in the buffer RAM 5, and then the entire read data after the correction is written back to the flash memory 2. That is to say, in the execution of the related-art refresh processing, write processing of the entire read data is involved in this manner, and thus there is a problem with a decrease in the data read speed.

Thus, in the third embodiment, at the time of reading the flash memory 2, read data is written into the redundant flash memory 2-rd in parallel as described above. And after an error portion is corrected in the buffer RAM 5 in response to satisfaction of the refresh execution condition, only a data portion related to the error portion written in the redundant flash memory 2-rd is rewritten by the data portion after the correction.

Thereby, compared with the related-art case, in which the entire read data is written back at the time of refresh, it is possible to effectively prevent a decrease in read speed at the time of refresh execution.

Here, if determined that it is not necessary to execute refresh as a result of the above-described error-check processing (if the refresh execution condition is not met), the data written in the redundant flash memory 2-rd in parallel is discarded.

Also, the data in the redundant flash memory 2-rd after the error portion is rewritten in response to the satisfaction of the refresh execution condition is written into a normal record area (that is to say, any one of the flash memories 2-0 to 2-3) at suitable timing after that. For example, it is desirable to write the data at the time of starting the memory apparatus 11 after that, or at the timing of detection of a state in which there is no request from the host device, etc.

### 3.2 Processing Procedure

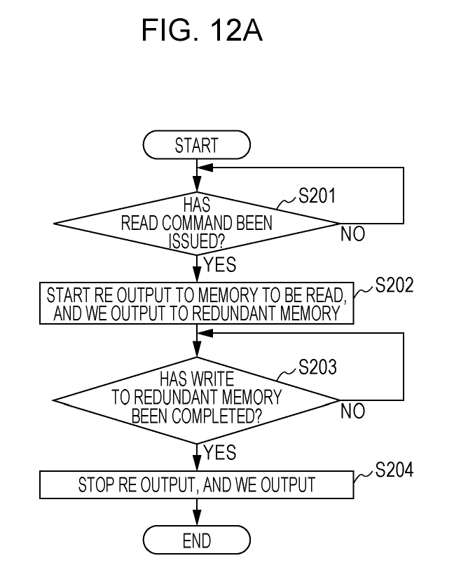

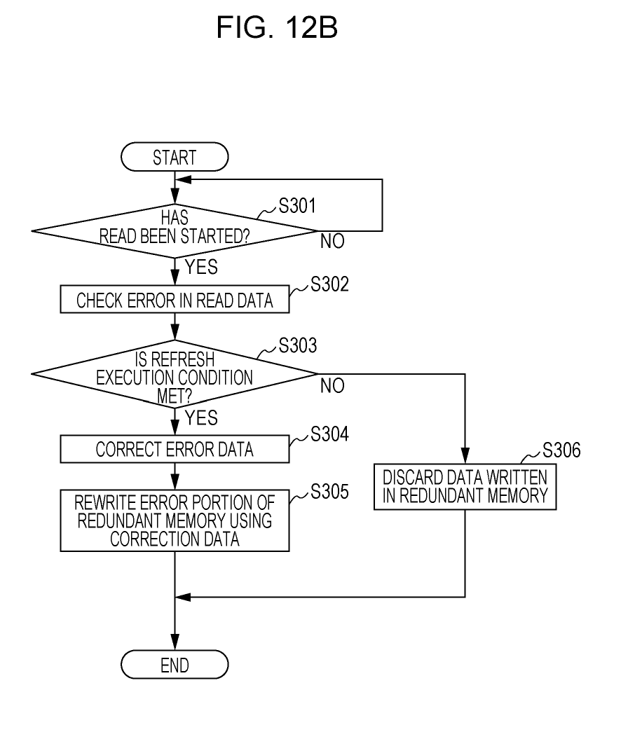

FIGS. 12A and 12B are flowcharts illustrating a specific processing procedure to be carried out in order to perform the memory control method according to the third embodiment described above.

FIG. 12A illustrates processing for achieving parallel writing at the time of reading. FIG. 12B illustrates processing for achieving control depending on whether the refresh execution condition is met or not.

The processing illustrated in FIG. 12A and the processing illustrated in FIG. 12B are performed by the controller 11 in parallel.

First, a description will be given of the processing illustrated in FIG. 12A.

In FIG. 12A, a read command is waited in step S201. That is to say, a read command from the host device is waited.

If a read command is received, the processing proceeds to step S202, and performs processing for starting to output a read enable signal RE to a memory to be read, and to output write enable signal WE to a redundant memory. That is to say, the processing is performed in order to start outputting a read enable signal RE to the read-target flash memory 2 identified from the above-described read command, and outputting a write enable signal WE to the redundant flash memory 2-rd.

In this regard, the processing in step S202 is the same as the processing in step S102, which has been described in FIG. 7, except that an output target of the read enable signal RE and an output target of the write enable signal WE are different, and thus the descriptions thereof will be omitted.

After output-start processing in step S202 is performed, in step S203, the processing is waited until writing to the redundant memory is completed. That is to say, the processing is waited until all the read data instructed by the above-described read command is written into the redundant flash memory 2-rd.

When writing to the redundant memory is completed, the processing proceeds to step S204, and processing for stopping output of the read enable signal RE and output of the write enable signal WE. That is to say, in this case, the toggle of the strobe signal ought to be stopped in the same manner as the processing in step S104.

After the processing in step S204 is performed, the processing illustrated in FIG. 12A is terminated.

Next, in FIG. 12B, in step S301, the processing is waited until reading is started. That is to say, the processing is waited until reading is started in response to the read command from the above-described host device.

When start of reading is detected, in step S302, error check of the read data is performed. That is to say, error check is performed on the read data stored in the buffer RAM 5 from the flash memory 2 to be read through the data line Ldt.

After the error check in step S302 is performed, in step S303, a determination is made on whether the refresh execution condition is met or not.

In this example, it is assumed that, for example, a condition in which an error portion has reached a predetermined upper limit value as the refresh execution condition is set.

In this regard, as the refresh execution condition, for example, it is possible to set a condition in which the number of reading the data portion to be a read target (for example, for each block) up to the present may be added.

In step S303, if an affirmative result is obtained by satisfaction of the refresh execution condition, the processing proceeds to step S304, and correction processing of error data is performed.

That is to say, a portion determined to be an error by the error-check processing in step S302 is corrected among the read data stored in the buffer RAM 5.

After the correction processing on the error data is performed in step S304, the error portion of the redundant memory is rewritten by the correction data in step S305. That is to say, among the read data that has been written in the redundant flash memory 2-rd, only the data portion related to the error portion corrected in step S304 is rewritten by the same data portion after the correction.

On the other hand, in step S303, if a negative result is obtained by the negation of the refresh execution condition, the processing proceeds to step S306, and processing for discarding the data written in the redundant memory is performed. For the processing in step S306, an instruction is given in order to suspend writing to the redundant flash memory 2, and to delete the written data. At this time, only processing for updating the management information may be performed so that the read data written in the redundant flash memory 2 is handled as if having been deleted, or processing for actually deleting the recorded portion of the read data may be performed at the same time.

After the discard processing in step S306 is performed, or the rewriting processing by step S305 is performed, the processing illustrated in FIG. 12B is terminated.

In this regard, it goes without saying that a memory control method according to the above-described third embodiment may be applied to the case where the DDR standard is employed as in the second embodiment in the same manner.

Also, in the above, a description has been given of the case where the redundant flash memory 2-rd is separately disposed in addition to the flash memories 2 used for normal record areas. However, a flash memory 2 used for the redundant flash memory 2-rd may be suitably selected and used from the flash memories 2.

### 4. Variations

In the above, a description has been given of the embodiments according to the present disclosure. However, the present disclosure should not be limited to the embodiments described so far.

For example, in the above-described description, an example in which read data is written into only one flash memories 2 in parallel has been given. However, it is possible to write the read data into a plurality of flash memories 2 in parallel, as a matter of course.

Also, in the descriptions so far, a configuration is exemplified in which the read/write enable signals are supplied to the flash memory 2 through the common enable signal line Le. However, it is also possible to have a configuration in which the signal line supplying the read enable signal and the signal line supplying the write enable signal are disposed separately.

Also, a parallel write method according to the present disclosure can be applied to the following case.

Here, in a NAND-type flash memory, when small-sized data (data having a size smaller than a block size) is written, if those data are merged into a continuous area every time, a decrease in writing speed occurs. Accordingly, a method of recording small-sized data in an area differently from a normal record area, and then merging the data into a continuous area at a certain different point in time is employed.

In such a case, it is thought that small-sized data is recorded into a redundant flash memory 2 once, and when it becomes necessary to merge the data into a continuous area, those small-sized data is copied from the redundant flash memory 2 to the flash memory 2 of the merging destination. It is possible to apply a parallel write method according to the present disclosure to the occasion of the data copy from the redundant flash memory 2 to the flash memory 2 of the merging destination.

In this case, it is also possible to read and write at the same time so that copy time can be shortened.

Also, in the present disclosure, it is possible to employ configurations described in the following (1) to (9).

(1) A memory apparatus including:

a plurality of flash memory sections connected to a common data line; and

a control section configured to perform control for data read/write on the plurality of flash memory sections,

wherein the control section performs control so as to give a read instruction to a first flash memory section among the plurality of flash memory sections to output read data from the first flash memory section on the common data line, and to give a write instruction to a second flash memory section other than the first flash memory section to write the read data obtained on the common data line into the second flash memory section with timing in accordance with timing of outputting the read data from the first flash memory section.

(2) The memory apparatus according to (1),

wherein the control section gives the read instruction and the write instruction by a read enable signal and a write enable instruction, respectively.

(3) The memory apparatus according to (2),

wherein the write instruction is given by the write enable signal indicating write instruction timing, and at timing delayed for a predetermined time period from bit read timing indicated by the read enable signal.

(4) The memory apparatus according to (2) or (3),

wherein a signal line for supplying the read enable signal and the write enable signal from the control section to the flash memory sections is a common line for each of the flash memory sections.

(5) The memory apparatus according to any one of (1) to (4),

wherein the control section gives the read instruction and the write instruction to perform reading and writing, respectively, at the time of data copy, from the first flash memory section to the second flash memory section, involved in garbage collection processing.

(6) The memory apparatus according to (1), further including a DQS signal line connected between the control section and each of the flash memory sections in compliance with a DDR (Double Data Rate) standard,

wherein the control section generates a DQS input signal indicating write timing in accordance with data read timing from the first flash memory section to be a read target, and supplies the DQS input signal onto the DQS signal line of the second flash memory section to be a write target in order to perform control so as to write the read data from the first flash memory section, obtained on the common data line into the second flash memory section.

(7) The memory apparatus according to (6),

wherein the control section generates the DQS input signal by giving a delay of a predetermined time period to the DQS output signal from the first flash memory section.

(8) The memory apparatus according to any one of (1) to (7), further including a buffer memory connected to the common data line,

wherein the control section performs error check on the read data, from the first flash memory section, stored in the buffer memory, and on the basis of a result thereof, if error correction is determined to be necessary, the control section controls to modify only a data part necessary for error correction among the read data written into the second flash memory section.

(9) The memory apparatus according to any one of (1) to (8),

wherein if determined that error correction is not necessary on the basis of the result of the error check, the control section controls so as to discard the read data written in the second flash memory section.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A memory apparatus comprising:
a plurality of flash memory sections connected to a common data line; and
a control section configured to perform control for data read/write on the plurality of flash memory sections,
wherein the control section performs control so as to give a read instruction to a first flash memory section among the plurality of flash memory sections to output read data from the first flash memory section on the common data line, and to give a write instruction to a second flash memory section other than the first flash memory section to write the read data obtained on the common data line into the second flash memory section with timing in accordance with timing of outputting the read data from the first flash memory section.

2. The memory apparatus according to claim 1,
wherein the control section gives the read instruction and the write instruction by a read enable signal and a write enable instruction, respectively.

3. The memory apparatus according to claim 2,
wherein the write instruction is given by the write enable signal indicating write instruction timing, and at timing delayed for a predetermined time period from bit read timing indicated by the read enable signal.

4. The memory apparatus according to claim 2,
wherein a signal line for supplying the read enable signal and the write enable signal from the control section to the flash memory sections is a common line for each of the flash memory sections.

5. The memory apparatus according to claim 1,
wherein the control section gives the read instruction and the write instruction to perform reading and writing, respectively, at the time of data copy, from the first flash memory section to the second flash memory section, involved in garbage collection processing.

6. The memory apparatus according to claim 1, further comprising a DQS signal line connected between the control section and each of the flash memory sections in compliance with a DDR (Double Data Rate) standard,
wherein the control section generates a DQS input signal indicating write timing in accordance with data read timing from the first flash memory section to be a read target, and supplies the DQS input signal onto the DQS signal line of the second flash memory section to be a write target in order to perform control so as to write the read data from the first flash memory section, obtained on the common data line into the second flash memory section.

7. The memory apparatus according to claim 6,
wherein the control section generates the DQS input signal by giving a delay of a predetermined time period to the DQS output signal from the first flash memory section.

8. The memory apparatus according to claim 1, further comprising a buffer memory connected to the common data line,
wherein the control section performs error check on the read data, from the first flash memory section, stored in the buffer memory, and on the basis of a result thereof, if error correction is determined to be necessary, the control section controls to modify only a data part necessary for error correction among the read data written into the second flash memory section.

9. The memory apparatus according to claim 8,
wherein if determined that error correction is not necessary on the basis of the result of the error check, the control section controls so as to discard the read data written in the second flash memory section.

10. A memory control apparatus for performing data read/write control on a plurality of flash memory sections connected to a common data line, the memory control apparatus performing control comprising:
giving a read instruction to a first flash memory section among the plurality of flash memory sections to output read data from the first flash memory section on the common data line; and
giving a write instruction to a second flash memory section other than the first flash memory section to write the read data obtained on the common data line into the second flash memory section with timing in accordance with timing of outputting the read data from the first flash memory section.

11. A method of controlling a memory for performing data read/write control on a plurality of flash memory sections connected to a common data line, the method comprising:
giving a read instruction to a first flash memory section among the plurality of flash memory sections to output read data from the first flash memory section on the common data line; and
giving a write instruction to a second flash memory section other than the first flash memory section to write the read data obtained on the common data line into the second flash memory section with timing in accordance with timing of outputting the read data from the first flash memory section.
